(19) United States
(12) Patent Application Publication
(10) Pub. No.: US 2006/0261964 A1
(43) Pub. Date: Nov. 23, 2006

(54) Safety device for laboratory work, especially for liquid chromatography systems

(76) Inventor: Thomas Maetzke, Basel (CH)

Correspondence Address: JORDAN AND HAMBURG LLP, 122 EAST 42ND STREET, SUITE 4000, NEW YORK, NY, 10168, US

(21) Appl. No.: 10/554,141

(22) PCT Filed: Mar. 23, 2004
(86) PCT No.: PCT/CH04/00176

§ 371 Date: Nov. 14, 2005

(30) Foreign Application Priority Data
Apr. 22, 2003 (CH) 71403

(51) Int. Cl. G08B 21/00

(52) U.S. Cl. 340/605

(57) ABSTRACT

A safety device for laboratory work, especially for fluid chromatography systems includes a level measuring arrangement which is connected to a tank and generates an alarm signal upon detection of a certain liquid level in the tank. The level measuring arrangement is also connected to at least one laboratory working surface and also produces an alarm signal when liquid is detected running over the at least one laboratory working surface. The level measuring arrangement is connected to a monitoring device embodied as a power supply unit in the form of a liquid control interface (LCI), the monitoring device containing a plurality of safety circuits and introducing a time-delayed circuit interruption when an alarm is generated by one of the safety circuits.

The invention relates to a safety device for laboratory work, in particular for liquid chromatography systems in accordance with the preamble to Patent Claim 1.

The invention is particularly suitable, however, not only for use in the field of high-pressure liquid chromatography (HPLC) or in the field of medium-pressure liquid chromatography, where the escape of volatile, readily combustible and toxic solvents, which are pumped there at quite high flow rates, for example at 100 ml/min, must be avoided.

Previously disclosed in EP 0 333 251 A2, for example, is a dishwasher, which is provided with an overflow pipe to restrict the liquid level in the machine, in conjunction with which the overflow pipe is equipped with a siphon-like part. The siphon-like part exhibits a reversed U-shaped bend in the overflow pipe.

Previously disclosed in FR 2 776 381 A1 is a device to indicate the fluctuation in the liquid level of liquids present in a container. The device comprises a float, which is able to move up or down in a tube. The float is attached to a magnetic body, which is able to move backwards and forwards in a second tube. Magnetic contacts are provided with the second hose at desired levels. As soon as the magnetic body comes into the vicinity of these contacts, an alarm signal is triggered.

Described in U.S. Pat. No. 6,276,200 B1 is a control system for a liquid level in conjunction with a swimming pool. This system exhibits a sensor, which is attached to a mounting device. The sensor is in a position to transmit signals. In the event of a change in the liquid level, a delivery valve can be activated or deactivated by the transmitted signals, which allows replacement water to flow to the swimming pool.

Previously disclosed in WO 01/43867 A1 is a system for controlling a separating unit for the multi-phase separation of liquids. In this system, a level for one or more liquids is set in the separating unit in relation to a reference value. The reference value and the liquid level converted into a pressure are passed to a pressure-sensitive, mechanical arrangement, the movement of which is transmitted directly to a mechanical control unit. This is connected to a monitoring device.

Previously disclosed in EP 1 106 254 A2 is a disposal system for liquid waste substances at a laboratory workstation. This disposal system comprises a receiving container, which is allocated to the laboratory workstation and/or a laboratory workbench, and exhibits an inlet for the waste substances, a suction connection and an aeration connection. A mobile collecting container is provided for the purpose of improved disposal of the waste substances. A level monitoring device is allocated to the receiving container, which activates an optical or acoustical signal when the waste substances reach a predetermined level in the receiving container. The monitoring device has a sensor for this purpose, which is retained externally by a support in a certain position in relation to the receiving container and, on reaching the set level, generates a control signal or triggers the signal. The sensor can be an effector or an ultrasound sensor, for example. A signal produced by another level monitoring device can be used to indicate the level and/or for operational planning, which takes into account the period for which the capacity of the tank, for example a bulk container, will remain adequate. The latter monitoring device utilizes a float for this purpose, the vertical position of which in each case is definitive for the signal output in each case. In accordance with this specification, as previously mentioned, one or more sensors can be provided which measure physical parameters, for example the pressure, temperature or concentration of the waste substance in the container and, if necessary, trigger an alarm by means of an alarm device or generate a signal to switch off an associated pump. A suitable sensor can be connected to the pump via a signal wire, so that the supply is switched off if a condition for the waste substance in the collecting container is not met, for example if the maximum level is reached or if an undesired chemical reaction takes place.

The object of the invention is to make available a safety device of the aforementioned kind, which lends itself to more varied applications.

This object is achieved in accordance with the invention by a safety device having the characterizing features of Patent Claim 1.

Advantageous further developments are the subject of the dependent Claims.

In the safety device in accordance with the invention, a level measuring arrangement is provided, preferably in the form of a drum adapter with a siphon, which adapter is screwed to a tank, and in which a level sensor is utilized. In accordance with one preferred embodiment, the drum adapter possesses two inlets, which lead directly into the tank executed as a waste container, and one inlet, which leads into the siphon and is connected to at least one laboratory working surface, so that liquid leaking onto the at least one laboratory working surface can be detected early, that is to say before the whole tank is full, and an alarm signal can be generated. The level measuring arrangement executed and arranged in accordance with the invention is thus in a position, in the sense of a dual effect, to detect both the liquid level in a tank, for example a solvent container, and also leaking liquid and accordingly in the latter case to transmit or trigger an alarm signal. This means that one and the same level measuring arrangement can serve at least two different purposes, as a result of which its area of application is significantly extended. The level measuring arrangement in accordance with the invention can thus be used for the detection of a certain liquid level and/or for the detection of a liquid that has leaked, for example, onto a laboratory working surface. An alarm signal can be triggered in this way when the tank is full or if, for example, a solvent is collected from laboratory working surface.

In accordance with an advantageous further development, the level measuring arrangement, namely preferably the aforementioned drum adapter, exhibits a siphon-like interior, for example, into which liquid from a certain liquid level in the tank and/or on which liquid leaking onto the at least one laboratory working surface can flow, and to which a level limit switch, preferably a vibration limit switch, is allocated. The siphon-like interior can also be used for the collection of different liquids, namely the liquid from a tank and a leaking liquid. The level limit switch establishes whether any liquid is present in the interior and can then trigger an alarm signal regardless of the source of the liquid.

In accordance with another further development of the invention, the level sensor projects from above down into the siphon of the drum adapter, which preferably exhibits a transcurrent hole in a side wall of its interior connecting the interior of the tank to the interior of the siphon of the drum adapter. The level measuring arrangement as a whole consisting of a drum adapter with a siphon and level limit switch in turn projects down into the tank from above. In this way, liquid can then enter the interior of the level measuring arrangement, namely into the siphon, in a simple manner when the liquid in the tank has reached a certain level. The transcurrent hole thus serves as a form of overflow.

In accordance with a preferred further development the level measuring arrangement, namely the drum adapter, has a bowl-like element, which is preferably screwed via a thread on its upper side to the lower end of a longitudinal hole in the main part of the level measuring arrangement, namely the drum adapter, in conjunction with which the aforementioned main part preferably exhibits a supplementary hole discharging into this longitudinal hole, through which the liquid leaking on a laboratory working surface can flow into the interior of the level measuring arrangement. The bowl-like element, also referred to as the siphon, thus collects the leaking liquid, so that the area of application of the level limit switch, which, as already mentioned, is allocated to the interior and thus to the bowl-like element, is extended. This is thus able to detect leaking liquid at an early stage. The bowl-like element can be emptied easily with the help of the screwed connection between the bowl-like element and the main part of the drum adapter, so that it together with the entire level measuring arrangement are again ready for use after only a short time. With the help of the supplementary hole of the drum adapters, a simple means is afforded on the one hand for connecting the level measuring arrangement to the point at which a liquid can emerge, and in particular overflow, and on the other hand for leading the liquid emerging at that point for a short distance to the interior of the bowl-like element, where small quantities of liquid can already be detected. The safety device in accordance with the invention is thus in a position to detect even small quantities of liquid and to generate an alarm signal at an early stage.

In accordance with another further development, the level measuring arrangement is in addition a drum adapter. This can be provided with a G2 Imperial standard (inch) thread and thus forms together with the level limit switch a universal level measurement device for the protection of tanks against overfilling, for example waste containers, preferably in liquid chromatography. The drum adapter is preferably made of metal (for instance stainless steel or aluminum) or from an inert plastic and is screwed to the tank, in particular a waste container for liquid substances. The safety device in accordance with the invention is thus capable of being connected to a plurality of tanks and is as such suitable for use in a wide range of applications. It can be reused as often as required.

In accordance with a particularly preferred further development of the invention, the level measuring arrangement is connected to a monitoring device preferably exhibiting a plurality of safety circuits and executed in the form of a so-called Liquid Control Interface, referred to as LCI, which preferably communicates with analysis or control software, for example chromatography software. The monitoring device provides the central power supply unit for an analysis system, for example a preparative HPLC system, and switches this off, preferably with a time delay, in the presence of an alarm signal from one of the safety circuits. The area of application of the safety device in accordance with the invention is further significantly increased by the monitoring device. Finally, a plurality of safety circuits can be monitored in this way. The communication by the monitoring device with the analysis or control software, preferably in the form of a relay signal, makes it possible for a process that is still in progress to be completed. Such a process lasts for about 15 minutes, for example, in a chromatography process. The software is thus in a position to implement the end phase of the process in the proper sequence of events. An ordered shut-down sequence can thus take place in this way, by first ending the process and then switching off the power supply. The monitoring device can also be executed in such a way that the power supply is switched off after a time delay of around 20 minutes, so that the system, including when the software is not working correctly, is switched off automatically after the last-mentioned period. An additional timer function on the monitoring device is preferably capable of being switched on manually, which requires a signal in the form of an impulse at regular intervals from the analysis or control software. If this impulse does not arrive regularly or if it is absent, the monitoring device can switch off the system, for example within 4 minutes.

Liquid-carrying components, such as pumps, are advantageously capable of being supplied with electrical energy via the central power supply unit. Switching-off of the liquid-carrying components is then assured, for example, when the level measuring arrangement detects leaking liquid. The monitoring device can be executed in such a way that the liquid-carrying components are switched off immediately in the event of the detection of leaking liquid. If the level measuring arrangement detects that the tank is full, it is also possible, as previously mentioned, for delayed switching-off to be used in such a way that a running process can still be completed.

In accordance with another further development of the invention, the monitoring device is executed in such a way that the maximum and/or the minimum liquid level in a tank, for example a liquid storage container, is detectable. It is also possible in this way, to connect the monitoring device not only to waste containers, but also to storage containers for liquid substances. An alarm signal is triggered at a minimum liquid level in the latter case, whereby the switching-off process can also be initiated once more. At the same time, a signal can also be transmitted again to the software in this case, which permits an already running process to be completed. The monitoring device can also be executed in such a way that a plurality of connections for storage containers are provided. The area of application of the safety device in accordance with the invention is further increased in this way. The monitoring device can thus be in a position to monitor the liquid level of a waste container, leaking solvent, the liquid level of a plurality of storage containers and the system status of the control software, to trigger an alarm signal and to switch off the power supply with a time delay, as soon as one of the safety circuits indicates an alarm status. Monitoring of the system status of the control software may include the question of whether the chromatography data system still maintains control over the HPLC system, in particular over the pumps of the system. The safety device in accordance with the invention can thus also operate fully automatically and, for example, can permit overnight working. Even if the software is not working correctly, the monitoring device can initiate switching-off of the entire system.

Advantageously the monitoring device in the latter case has additional measurement sensors and preferably a timer relay, which, in the event of an alarm, generates a signal after a preset time delay and in so doing causes a power relay to open, which then interrupts the power supply to a mains outlet preferably in the form of an outlet socket. A second timer relay that is preferably capable of being switched on and off can also be provided, which at preset time intervals requests a signal in the form of an impulse, for example from control software, and, in the absence of the impulse signal, itself generates a signal and in this way causes a power relay to open, which then interrupts the power supply to a mains outlet preferably in the form of an outlet socket.

Illustrative embodiments of the subject of the invention are explained below with reference to the drawings, whereby all the described and/or graphically represented characteristics, either alone or in any desired combination, constitute the subject of the present invention independently of their inclusion in the Patent Claims or their relationship. The Figures show the following:

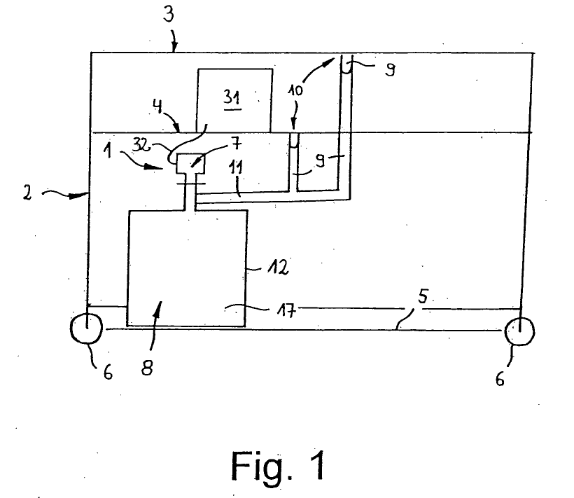

FIG. 1 is a schematic side view of a safety device for laboratory work;

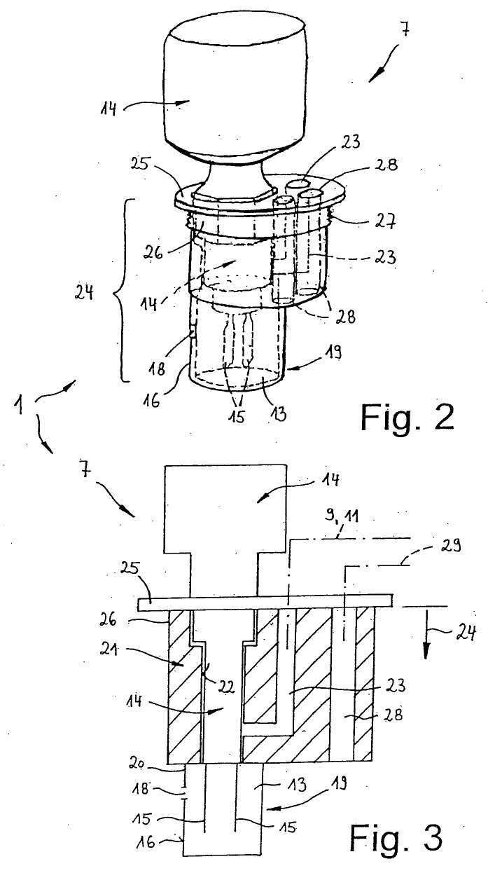

FIG. 2 is a schematic, perspective view of a level measuring arrangement of the safety device;

FIG. 3 is a schematic, partial section through the level measuring arrangement; and

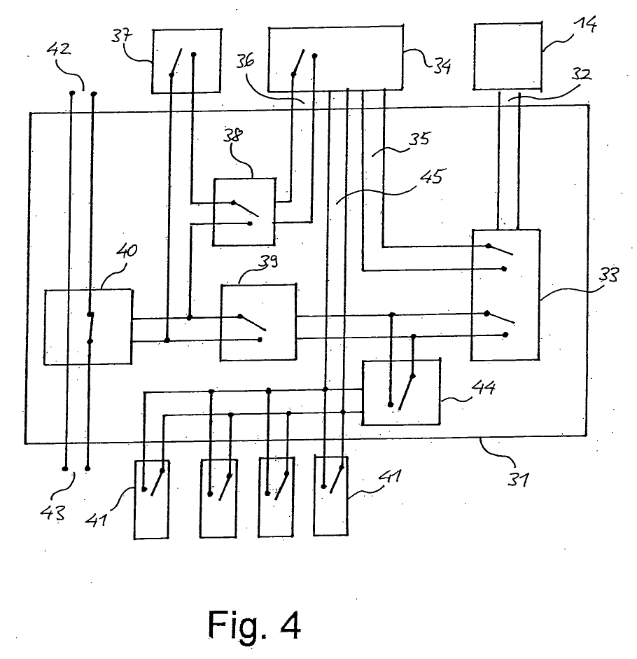

FIG. 4 is a schematic circuit diagram for a monitoring device for the safety device.

Illustrated schematically as a side in FIG. 1 view is a safety device 1 for laboratory work, in particular for liquid chromatography systems. In accordance with FIG. 1, the safety device 1 is present on a laboratory trolley 2, which exhibits a first, upper laboratory working surface 3, a subjacent second, lower laboratory working surface 4 and a low-level floor 5. The latter is arranged beneath the top edges of the wheels 6 of the laboratory trolley 2.

The safety device 1 has a level measuring arrangement 7, which is connected to a tank 8 and, upon detection of a certain liquid level in the tank 8, generates an alarm signal.

In accordance with the invention, the level measuring arrangement 7 is additionally connected to at least one of the laboratory working surfaces 3, 4 and is executed in such a way that the alarm signal is also generated when it detects leaking liquid on the at least one laboratory working surface 3, 4. The level measuring arrangement 7 is connected for this purpose via drainage lines 9 with a drain channel 10 provided in the one or more laboratory working surfaces in each case.

In the illustrative embodiment shown in FIG. 1, the level measuring arrangement 7 is connected to both laboratory working surfaces 3, 4 via the aforementioned drainage lines 9. Both drainage lines 9 discharge into a common line 11, which is executed in such a way that it is inclined towards the tank 8, so that a gradient is produced from the drainage lines 9 in the direction of the container.

The tank 8 can, for example, be a waste container 12 for liquid products, in particular for solvents.

As illustrated in greater detail in FIGS. 2 and 3, the level measuring arrangement 7, namely a drum adapter 24 for the same, has an interior 13. Above a certain level in the tank 8, liquid flows into this interior 13 through a transcurrent hole 18 described below in greater detail. Also, any liquid leaking onto the at least one laboratory working surface 3, 4 flows through a supplementary hole 23, as described below, and into this interior, as explained in even greater detail below. A measurement sensor in the form of a level limit switch 14, preferably a so-called vibration switch, the vibration forks 15 of which project into the interior, is allocated to the interior 13.

In accordance with an embodiment represented only schematically in FIG. 1, the level measuring arrangement 7 with the level limit switch projects from above and down into the tank 8. The level measuring arrangement 7, namely a drum adapter 24, exhibits on a side wall 16 of its interior 13 a transcurrent hole 18 connecting the interior 17 of the tank 8 to the interior 13 of the drum adapter 24. As indicated in FIGS. 2 and 3, the transcurrent hole 18 in the side wall 16 is arranged above the lower end of the vibration forks 15.

The drum adapter 24 of the level measuring arrangement 7 has a bowl-like element 19 exhibiting the interior 13, which is screwed on its upper side 20 to the main part 21 of the drum adapter 24. This screwed connection can be effected between the upper side 20 of the bowl-like element 19 and the lower end of a longitudinal hole 22 of the main part 21. In the latter case, the external diameter of the upper side 20 of the bowl-like element 19 corresponds more or less to the internal diameter of the longitudinal hole 22.

Liquid which is produced during the chromatography process can also be led directly into the tank, for example a waste drum, however, through two additional holes 28.

The main part 21 of the drum adapter 24 exhibits a supplementary hole 23 discharging into the longitudinal hole 22, through which liquid leaking onto one of the laboratory working surfaces 3, 4 can flow into the interior 13 of the drum adapter 24. It is also possible, however, for liquid to flow not through the main part 21 of the drum adapter 24, but via the transcurrent hole 18 executed as an overflow and into the interior 13. The supplementary hole 23 is of L-shaped execution, in accordance with the embodiment of the invention shown in FIG. 3, and is connected via the line 11, indicated only as a dot-dash line in FIG. 3, or generally via a drainage line 9 to the working surface 3, 4 in each case.

In accordance with a preferred embodiment of the invention, the level measuring arrangement 7 exhibits the so-called drum adapter 24 and the level limit switch 14. The drum adapter 24 is, as indicated in FIG. 3, provided and executed beneath a flange 25. The drum adapter 24 preferably has, as indicated in FIG. 2, a G2 Imperial standard (inch) thread 27 in its upper area 26, which thread is capable of being screwed into a corresponding counter thread in the tank 8 (not shown here). In the interests of greater clarity, the thread 27 is omitted in FIG. 3. It is clear that the drum adapter can also be provided with other types of thread.

As indicated in FIGS. 2 and 3, the level limit switch 14 extends on the one hand inside the longitudinal hole 22 through the main part 21 of the drum adapter 24, in conjunction with which the vibration forks 15, which are present at the lower end of the level limit switch 14, project into the interior of the cavity executed as a siphon; on the other hand, the housing of the level limit switch also extends partially above the flange 25. The level limit switch 14 is preferably detachably attached to the main part 21.

In accordance with the embodiment of the invention shown in FIG. 2, two further holes 28 are provided alongside the supplementary hole 23 in the main part 21 of the drum adapter 24. These holes provide direct access into the interior 17 of the tank 8. The further holes 28 thus represent a so-called direct inlet. The connections can be made using stainless steel tubular elbows with hose olives, onto which drainage hoses are pushed and crimped. A tubular elbow 29 is represented only as a dot-dash line in FIG. 3 and is generally pushed into the hole 28 as far as it will go. The tubular elbows 29 can have different lengths, so that they cannot be mistaken for one another. Another of the direct inlets 28 can, for example, be used as an inlet for the steel capillaries (not shown here) of an HPLC system. On the other hand, the supplementary hole 23 provides a connection to the bowl-like element 19, known as the siphon. Any liquid which finds its way via this inlet to the tank 8, for example to the waste container 12, is accordingly led via the siphon-like element 19.

In accordance with a preferred embodiment, the level measuring arrangement 7 is connected to a monitoring device 31, also referred to as a Liquid Control Interface or abbreviated to LCI, preferably exhibiting a plurality of safety circuits, via a signal cable 32 (see FIGS. 1, 4).

The monitoring device contains a plurality of electrical circuit elements, which are described in greater detail below.

In accordance with FIG. 4, in which a schematic circuit diagram for the monitoring device 31 is shown, the monitoring device 31 has as its central power supply unit a power relay 40, preferably a semiconductor relay. The power relay 40 is connected between the mains inlet 42 and the mains outlet 43, also referred to below as the outlet socket. In the event of an alarm being triggered by the level limit switch 14 of the level measuring device, the signal is led via the signal cable 32 to the monitoring device 31 and is transformed by a measuring transducer 33 into a relay signal. This relay signal is then led to a timer relay 39. At the same time, the signal is forwarded by means of a signal transmission line 35 to the control software for example in a Personal Computer 34, also referred to as a PC. After a preset time delay on the timer relay 39, the signal is led to the power relay 40, which then interrupts the power supply to the mains outlet 43 in the form of the outlet socket.

As illustrated in the embodiment of the invention shown in FIG. 4, further measurement sensors 41 in the form of level meters (four such elements are represented schematically in FIG. 4) can be connected to the monitoring device 31, the connections for which are linked together within the monitoring device 31 in a parallel circuit. In the event of an alarm, this generates a signal via a relay 44, which signal is led to the timer relay 39. The latter initiates the delayed switching-off of the power relay 40. At the same time, a signal is forwarded by means of a signal transmission line 45 to the control software in the PC 34.

In accordance with the embodiment of the invention shown in FIG. 4, the monitoring device 31 exhibits an additional monitoring function on the control panel of the device in the form of a second timer relay 38 capable of being switched on and off manually via a switch 37. This must receive an external signal, such as an impulse, for example from the control software of a liquid chromatography system, at preset intervals via an impulse transmission line 36. Otherwise, it transmits a signal to the power relay 40, which then interrupts the power supply to the mains outlet 43, for example the aforementioned outlet socket, without any delay.

In FIG. 4 the relays 33, 38, 39 and 44 and the measurement sensors 41 are represented schematically as closing relays. It is clear that the circuit diagram with the same elements can also be constructed with opening relays. In addition, the entirety of the switching elements represented schematically in FIG. 4 can be executed as a processor, that is to say as an integrated circuit.

The monitoring device 31 preferably communicates with analysis and/or control software, for example chromatography software, and at the same time forms the central power supply unit for an analysis system, for example a preparative HPLC system. The monitoring device 31 switches off the analysis system in the presence of an alarm signal from one of the safety circuits, as previously mentioned, preferably with a time delay. In the first instance liquid-carrying components (not shown here), preferably pumps, are capable of being supplied with electrical energy via the monitoring device 31, so that these can be switched off safely in the presence of an alarm signal.

The monitoring device 31 is designed in such a way that the maximum and/or the minimum liquid level in a tank 8, for example in a liquid storage container, is also detectable. In this respect, the monitoring device can be connected both to the tank 8 executed as a waste container 12 and to further tanks (not shown here), which are executed as liquid storage containers.

The monitoring device 31 is thus designed as an intelligent solvent monitoring system with a plurality of safety circuits, which operate independently of the chromatography data system. The monitoring device can communicate by means of relay signals with chromatography software, so that this in turn can be triggered early for the corresponding actions. As previously mentioned, the monitoring device preferably provides the central power supply unit for the system, for example a preparative HPLC system. The solvent-carrying components, namely the pumps, are supplied with electrical energy in the first instance via the power supply unit. The monitoring device is in a position to interrupt the entire power supply for the system in the event of an alarm, in order to prevent the threat of an uncontrolled escape of solvent, if need be, to be precise in the case of a full tank, in particular a waste container, or, for example, because of a liquid leaking onto a laboratory working surface or, for example, also in the case of a software crash during unsupervised operation, for example during the night.

The monitoring device can monitor four system statuses, for example, during operation. As previously indicated, this can be the level of a waste container on the one hand; on the other hand, solvent leaking onto a laboratory working surface can be detected at an early stage, and the level of, for example, up to four liquid storage containers can be monitored; the system status of the control software can also be monitored, so that it is possible to verify whether the chromatography data system is still in control of the HPLC system, that is to say in the first instance control of the pumps.

As soon as the level sensor of the level measuring arrangement on the waste container responds, a residual volume generally remains available, so that a delayed switching-off sequence is implemented which permits the completion of a laboratory process that is running at the time, for example a chromatography process. At the same time, a signal in the form of a relay contact can be transmitted as an input to the control software, which will in fact end the running process, but cannot accept any further specimens for processing. At the end of the time delay, the power supply will then be interrupted in any case.

If a liquid, such as a solvent, leaks at one point on a laboratory working surface 3, 4, this will be led by the shortest possible path via the drainage line 9 and/or the line 11 to the level measuring arrangement in the interior 13 of the siphon-like element 19 of the drum adapter. As soon as a few millilitres have reached the level sensor, this will respond and will trigger the same shut-down sequence as for a full waste container. It is also possible to shut down operation of the system immediately in the last-mentioned case. As soon as the level in the interior 13 of the bowl-like element 19 of the drum adapter 24 of the level measuring arrangement 7 has reached a certain height, the frequency of the vibration forks 15 of the level limit switch 14 will change, causing an alarm signal to be generated.

An adequate liquid level in the liquid storage container can be monitored, for example, with so-called empty level sensors. In the case of an empty storage container, the monitoring device can transmit a signal as an input to the control software, so that this will in fact end the running process, but cannot accept any further specimens for processing. The empty level sensors may already respond when a small reserve remains in the storage container. In another case, the monitoring device can transmit a signal, as previously mentioned, and then in addition bring about the delayed switching-off of the entire system.

In addition, the monitoring device can be used to receive a signal from the control software at short time intervals, for example every 4 minutes, and otherwise to turn off the power supply immediately. This procedure can be sensible in the case of preparative HPLC systems, which are required to operate unsupervised for a long time. This function ensures that the chromatography data system still actually maintains control over the system that is in operation.

The operation of the safety device in accordance with the invention is described in more detail below.

The level measuring arrangement 7 with its drum adapter 24 is first screwed onto the tank 8, for example the waste container 12, with its external thread 27. The lines 9 and/or 11 and the tubular elbows 29 together with further lines are then introduced. Finally, the level limit switch 14 in the inner hole 22 of the main part 21 is introduced until the vibration forks 15 are situated beneath the transcurrent hole 18. In addition, the level limit switch 14 is connected by means of the signal line 32 to the monitoring device 31.

As soon as liquid finds its way through the transcurrent hole 18 or via the supplementary hole 23 into the interior 13 of the bowl-like element 19, so that the vibration forks 15 are immersed in liquid, the frequency of the vibration forks 15 changes. This triggers an alarm signal. In this respect, in accordance with the invention, an alarm signal is always triggered when liquid is present in the interior and in fact regardless of whether this liquid found its way through the transcurrent hole 18 from the interior 17 of the tank 8 into the interior 13 of the element 19 or via the supplementary hole 23 into the interior 13 of the element 19.

The level limit switch 14 is preferably a single part and can be lifted out as a whole from the main part 21 and the bowl-like element 19. The drum adapter 24 is, as previously mentioned, preferably made of metal (for instance stainless steel or aluminum) or an inert plastic. The transcurrent hole 18 permits not only the entry of liquid from the interior 17 of the tank 8 into the interior 13 of the level measuring arrangement 7, but also the exit of solvent, which finds its way via the supplementary hole 23 into the interior 13 of the level measuring arrangement 7.

In conjunction with disassembly, the level limit switch 14 and the lines including the tubular elbows are first lifted out and dismantled from the drum adapter. The drum adapter is then unscrewed from the tank and lifted out. Finally, the bowl-like element 19 is separated from the main part 21 of the level measuring arrangement 7, preferably by unscrewing.

A safety device for laboratory work has thus been made available, which lends itself to varied applications.

1. Safety device for laboratory work comprising a level measuring arrangement which is connected to a tank and, upon detection of a certain liquid level in the tank, generates an alarm signal, the level measuring arrangement is also connected via at least one drainage line to at least one laboratory working surface and generates an alarm signal when it detects leaking liquid on at least one laboratory working surface.

2. Safety device as claimed in claim 1, wherein the level measuring arrangement has an interior into which liquid from a certain liquid level in the tank and/or liquid leaking on the at least one laboratory working surface flows, and for which a level limit switch is provided.

3. Safety device as claimed in claim 2, wherein the level measuring arrangement projects down into the tank from above and has a transcurrent hole connecting the interior of the tank to an interior of the level measuring arrangement in a side wall of its interior.

4. Safety device as claimed in claim 2 or 3, wherein the level measuring arrangement has a bowl-like element having the interior which is connected via its upper side to the lower end of a longitudinal hole of a main part of the level measuring arrangement arranged above the bowl-like element.

5. Safety device as claimed in claim 4, wherein the main part of the level measuring arrangement has a supplementary hole discharging into the longitudinal hole, through which the liquid leaking onto the at least one laboratory working surface flows into the interior of the level measuring arrangement.

6. Safety device as claimed in claim 1, wherein the level measuring arrangement is also a drum adapter which is capable of being connected to the liquid container.

7. Safety device as claimed in claim 1, wherein the level measuring arrangement is connected to a monitoring device having a plurality of safety circuits which communicates with analysis and/or control software, forms the central power supply unit for an analysis system, and switches off the analysis system, in the event of an alarm signal from one of the safety circuits.

8. Safety device as claimed in claim 7, wherein liquid-carrying components are capable of being supplied with electrical energy via the central power supply unit.

9. Safety device as claimed in claims 7 or 8, wherein the monitoring device is designed in such a way that the maximum and/or the minimum liquid level in the tank is detectable.

10. Safety device as claimed in claim 9, wherein further measurement sensors for triggering an alarm in the event of a maximum and/or minimum liquid level in the tank in each case are connected to the monitoring device.

11. Safety device as claimed in one or other of claims 7 or 8 wherein the monitoring device comprises a timer relay which, in the event of an alarm, generates a signal after a preset time delay and in so doing causes a power relay to open, which then interrupts the power supply to a mains outlet.

12. Safety device as claimed in claim 11 wherein the monitoring device comprises a second timer relay, which at preset time intervals requests a signal in the form of an impulse, from control software and, in the absence of the impulse signal, itself generates a signal and in this way causes the power relay to open, which then interrupts the power supply to the mains outlet.

13. Safety device as claimed in claim 12, comprising means for switching the function of the second timer relay on and off.

14. Safety device claimed in claim 1, wherein the laboratory work is used for liquid chromatography systems.

15. Safety device as claimed in claim 2, wherein the limit switch comprises a vibration limit switch.

16. Safety device as claimed in claim 7, wherein the analysis and/or control software comprises chromatography software.

17. Safety device as claimed in claim 7, wherein the analysis system comprises a preparative HPLC system.

18. Safety device as claimed in claim 7, wherein the analysis system is switched off with a time delay.

19. Safety device as claimed in claim 8, wherein the liquid-carrying components comprises pumps.

20. Safety device as claimed in claim 11 or 12, wherein the measuring sensors comprise level meters.

21. Safety device as claimed in claim 11 or 12, wherein the mains outlet comprises an outer socket.
